(19) United States
(12) Patent Application Publication
(10) Pub. No.: US 2026/0005292 A1
(43) Pub. Date: Jan. 1, 2026

(54) MULTILAYER SOLID ELECTROLYTES AND BATTERIES CONTAINING THE SAME

(71) Applicant: Toyota Motor Engineering & Manufacturing North America, Inc., Plano, TX (US)

(72) Inventors: Shingo Ota, Ann Arbor, MI (US); Nikhilendra Singh, Ann Arbor, MI (US); Jeffrey Sakamoto, Brentwood, CA (US); Max J. Palmer, Santa Barbara, CA (US); Won Joon Suk, Ann Arbor, MI (US)

(73) Assignees: Toyota Motor Engineering & Manufacturing North America, Inc., Plano, TX (US); The Regents of the University of Michigan, Ann Arbor, MI (US)

(21) Appl. No.: 18/756,563

(22) Filed: Jun. 27, 2024

(51) Int. Cl. H01M 10/0562

(52) U.S. Cl. CPC H01M 10/0562; H01M 2300/0071; H01M 2300/008; H01M 2300/0094

(57) ABSTRACT

A solid electrolyte comprises a lithium lanthanum zirconium oxide (LLZO) solid electrolyte layer, a FeOCl—LiCl solid electrolyte layer, and an intermediate layer disposed between the LLZO layer and the FeOCl—LiCl layer. The intermediate layer comprises lithium (Li), oxygen (O), and at least one of phosphorous (P) and carbon (C).

### TECHNICAL FIELD

The present disclosure relates generally to solid electrolytes, and more particularly, to multilayer solid electrolytes.

### BACKGROUND

Electrolytes utilized in batteries are optimal when the electrolytes have a high conductivity, a wide electrochemical window, superior formability, and are non-flammable. However, it is difficult to meet all of these requirements using a single electrolyte material. FeOCl—LiCl is a composite solid electrolyte that has a high conductivity, superior formability, and is non-flammable. Lithium lanthanum zirconium oxide (Li₇La₃Zr₂O₁₂ or LLZO) is a solid electrolyte that has a high conductivity, a wide electrochemical window, and is non-flammable. Accordingly, it is desirable to form a solid electrolyte that utilizes both FeOCl—LiCl and LLZO.

The present disclosure addresses issues related to forming a multilayer solid electrolyte with a FeOCl—LiCl layer and a LLZO layer, and other issues related to multilayer solid electrolytes.

### SUMMARY

This section provides a general summary of the disclosure and is not a comprehensive disclosure of its full scope or its features.

In one form of the present disclosure, a solid electrolyte includes a lithium lanthanum zirconium oxide (LLZO) solid electrolyte layer, a FeOCl—LiCl solid electrolyte layer, and an intermediate layer disposed between the LLZO layer and the FeOCl—LiCl layer. The intermediate layer includes lithium (Li), oxygen (O), and at least one of phosphorous (P) and carbon (C).

In another form of the present disclosure a solid electrolyte includes a lithium lanthanum zirconium oxide (LLZO) solid electrolyte layer, a FeOCl—LiCl solid electrolyte layer, and an intermediate layer disposed between the LLZO layer and the FeOCl—LiCl layer. The intermediate layer is coated on the LLZO layer and sandwiched between the LLZO layer and the FeOCl—LiCl layer. Further, the intermediate layer includes lithium (Li), oxygen (O), and at least one of phosphorous (P) and carbon (C).

In still another form of the present disclosure, a solid electrolyte includes a lithium lanthanum zirconium oxide (LLZO) solid electrolyte layer, a FeOCl—LiCl solid electrolyte layer, and an intermediate layer disposed between the LLZO layer and the FeOCl—LiCl layer. The intermediate layer includes lithium (Li), oxygen (O), and at least one of phosphorous (P) and carbon (C). Further, a thickness of the intermediate layer is between about 1 nm and about 1000 nm, an initial resistance of the solid electrolyte is between about 200 ohms and 300 ohms, and an interfacial resistance of the solid electrolyte is between about 100 ohms and about 200 ohms.

Further areas of applicability and various methods of enhancing the above technology will become apparent from the description provided herein. The description and specific examples in this summary are intended for purposes of illustration only and are not intended to limit the scope of the present disclosure.

### BRIEF DESCRIPTION OF THE DRAWINGS

The present teachings will become more fully understood from the detailed description and the accompanying drawings, wherein:

FIG. 1 is a side view of a solid multilayer electrolyte according to the teachings of the present disclosure;

FIG. 2 is a Nyquist plot of the resistance of a solid multilayer electrolyte with a FeOCl—LiCl layer and a Li₇La₃Zr₂O₁₂ (LLZO) layer;

FIG. 3 is a plot of the total resistance of the solid multilayer electrolyte of FIG. 2 versus time;

FIG. 4 is a Nyquist plot of the resistance of a solid multilayer electrolyte with a FeOCl—LiCl layer, a LLZO layer, and an intermediate layer disposed between the FeOCl—LiCl layer and the LLZO;

FIG. 5 is a plot of the total resistance of the solid multilayer electrolyte of FIG. 4 versus time; and

FIG. 6 is a microstructure of an electrolyte according to the teachings of the present disclosure.

### DETAILED DESCRIPTION

The present disclosure provides a solid multilayer electrolyte (also referred to herein simply as “electrolyte”) configured to be utilized in solid-state batteries. As used herein, the terms “solid multilayer electrolyte” and “electrolyte” refer to a solid-state electrolyte that includes at least two solid-state electrolyte layers and an intermediate layer between the two solid-state electrolyte layers. Further, in one or more variations, a solid-state battery is configured to utilize the solid multilayer electrolyte of the present disclosure. In one form of the present disclosure, the electrolyte includes a FeOCl—LiCl solid electrolyte layer (also referred to herein a “FeOCl—LiCl layer”). The FeOCl—LiCL layer can, in one or more variations, is an FeOCL-LiCL layer that has undergone elemental substitution/is doped with at least one of the following elements: hydrogen (H), sodium (Na), potassium (K), magnesium (Mg), calcium (Ca), zinc (Zn), aluminum (Al), gallium (Ga), nickel (Ni), fluorine (F), bromine (Br), and iodine (I). In one form of the present invention, the electrolyte further includes a lithium lanthanum zirconium oxide (also referred to herein as “LLZO” or “Li₇La₃Zr₂O₁₂”) solid electrolyte layer. In one or more variations, the LLZO layer is an LLZO layer that has undergone elemental substitution/is doped with at least one of the following elements: H, Al, Ga, iron (Fe), Mg, Ca, strontium (Sr), barium (Ba), scandium (Sc), yttrium (Y), hafnium (Hf), niobium (Nb), tantalum (Ta), tungsten (W), tin (Sn), bismuth (Bi), cerium (Ce), praseodymium (Pr), and neodymium (Nd). In one form of the present invention, the electrolyte further includes an intermediate layer disposed between the LLZO layer and the FeOCl—LiCl layer. In some variations, the intermediate layer is disposed between and in direct contact with the LLZO layer and/or the FeOCl—LiCl layer, while in other variations one or more additional layers are disposed between the LLZO layer and/or the FeOCl—LiCl layer. As used herein, the region formed between the FeOCl—LiCl solid electrolyte layer and LLZO layer is referred to as the “electrolyte interface” (also referred to herein simply as “interface” and “interphase”). Additionally, as used herein, the term “interfacial resistance” refers to an opposition to a flow of electric charge at the interface between the FeOCl—LiCl solid electrolyte layer and LLZO layer.

In one or more non-limiting examples, the intermediate layer includes lithium (Li), oxygen (O), and at least one of phosphorous (P) and carbon (C). In such examples, the intermediate layer results in the electrolyte having a lower interfacial resistance than the electrolyte would have with the FeOCl—LiCl solid electrolyte layer and LLZO layer alone. The lower interfacial resistance is attributed to various qualities of the intermediate layer, such as the compatibility of the intermediate layer with the FeOCl—LiCl solid electrolyte layer and the LLZO layer which results in less chemical reactions occurring at the electrolyte interface than when the intermediate layer is not present. Specifically, an intermediate layer comprising Li, O, and P or C contributes to efficient charge transfer and has a high conductivity, resulting in a reduced interfacial resistance as described below. Not being bound by theory, an intermediate layer thickness of about 10 nanometers (nm) is sufficient to suppress undesired chemical reactions between the FeOCl—LiCL layer and the LLZO layer. For example, in some variations the intermediate layer has a thickness between about 10 nm and about 50 nm, e.g., between about 10 nm and about 40 nm, between about 10 nm and about 30 nm, or between about 10 nm and about 20 nm.

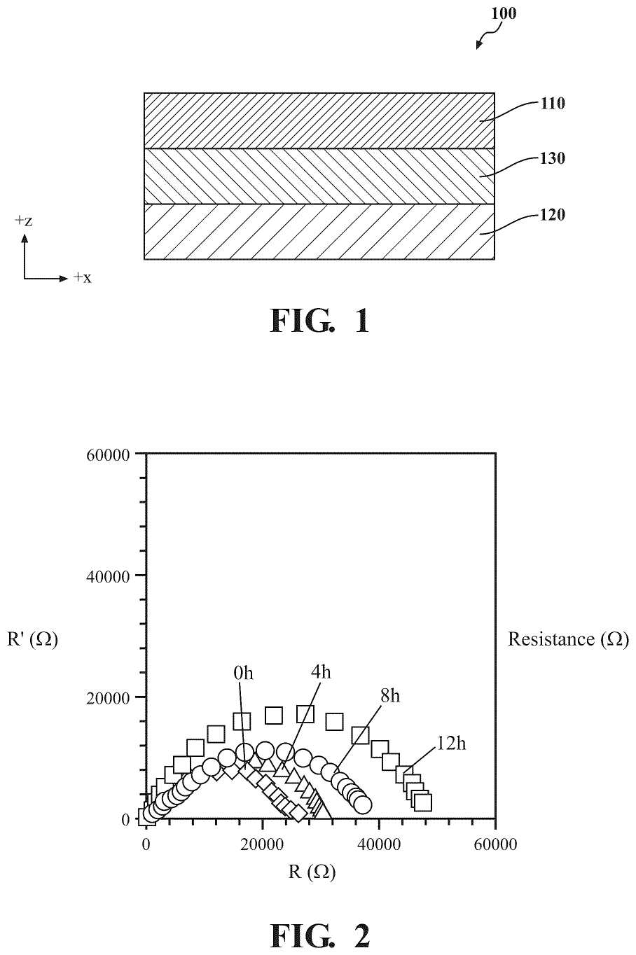

Referring to FIG. 1, one non-limiting example of a solid multilayer electrolyte 100 is shown. In one or more variations, the electrolyte includes a FeOCl—LiCl solid electrolyte layer 110, an LLZO solid electrolyte layer 120, and an intermediate layer 130 disposed between the FeOCl—LiCl layer 110 and the LLZO layer 120. In one or more non-limiting examples, the intermediate layer 130 is sandwiched between the FeOCl—LiCl layer 110 and the LLZO layer 120. That is, the intermediate layer 130 is in direct contact with both the FeOCl—LiCl layer 110 and the LLZO layer 120. Although FIG. 1 illustrates the intermediate layer 130 as being sandwiched between the FeOCl—LiCl layer 110 and the LLZO layer 120, it should be understood that, in one or more variations, additional layers can be disposed between the FeOCl—LiCl layer 110, the LLZO layer 120, and the intermediate layer 130. For example, an additional interlayer may be disposed between the FeOCl—LiCl layer 110 and the intermediate layer 130 to improve compatibility between the FeOCl—LiCl layer 110 and LLZO layer 120 in a manner that lowers interfacial resistance.

The FeOCl—LiCl layer 110 is highly conductive and has high formability, and the LLZO layer 120 is highly conductive and has a wide electrochemical window, which renders the FeOCl—LiCl layer 110 and the LLZO layer 120 favorable layers for a solid-state electrolyte. The intermediate layer 130 is an electrolyte layer that includes lithium (Li), oxygen (O), and at least one of phosphorous (P) and carbon (C). In one non-limiting example, the intermediate layer 130 includes Li, O, and P. In another non-limiting example, the intermediate layer 130 includes Li, O, and C. In yet another non-limiting example, the intermediate layer 130 includes Li, O, C, and P. In addition to Li, O, and P or C, the intermediate layer 130, in one or more variations, includes additional additives that reduce interfacial resistance even further. In one variation, the additive is boron (B), which enhances the conductivity of the electrolyte 100. In one or more non-limiting examples, the additives include other composites, such as lithium salts, polymer additives, metal oxides, and the like depending on the electrolyte 100.

The layers of the electrolyte 100 (i.e., the FeOCl—LiCl layer 110, the LLZO layer 120, and the intermediate layer 130) are, in one or more variations, assembled using various techniques. In one or more non-limiting examples, the layers 110-130 are prepared using deposition techniques (e.g., physical vapor deposition (PVD), chemical vapor deposition (CVD), sol-gel processes, sputtering, or other thin-film deposition methods) and then stacked using layer stacking techniques, such as pressing or lamination (e.g., the layers are individually prepared and then pressed/laminated together to form a multilayer structure). In one or more variations, the intermediate layer 130 is prepared as a thin film or coating that is configured to be coated directly on the FeOCl—LiCl layer 110 or the LLZO layer 120 during assembly of the electrolyte 100 before the FeOCl—LiCl layer 110 and the LLZO layer 120 are stacked.

The intermediate layer 130, in one or more non-limiting examples, is thinner than the FeOCl—LiCl layer 110 and the LLZO layer 120. In particular, the thickness of the intermediate layer 130 is thick enough to suppress chemical reactions between the FeOCl—LiCl layer 110 and the LLZO layer 120 and to lower the interfacial resistance between the FeOCl—LiCl layer 110 and the LLZO layer 120 yet thin enough so as to not increase the overall resistance of the assembled electrolyte 100. Non-limiting examples of the average thickness of the intermediate layer 130 include thickness between about 1 nanometers (nm) and about 1000 nm, between about 2 nm and about 100 nm, between about 2 nm and about 50 nm, between about 2 nm and about 40 nm, between about 2 nm and about 30 nm, between about 2 nm and about 20 nm, between about 5 nm and about 15 nm, and between about 3 nm and about 20 nm. In any case, after stacking and assembling the layers, in one or more non-limiting examples, the electrolyte 100 undergoes thermal treatment (e.g., on-site heating of the layers 110-130) to form the final solid-state electrolyte 100.

In one or more variations, the electrolyte 100 has a low initial resistance. Non-limiting examples of the average initial resistance of the electrolyte 100 include an initial resistance of between about 10 ohms (Ω) and about 500Ω, between about 50Ω and about 400Ω, between about 100Ω and about 300Ω, between about 200Ω and 300Ω, between about 270Ω and about 300Ω, and between about 280® and about 290Ω. Additionally, in one or more variations, the electrolyte 100 has a low interfacial resistance. Non-limiting examples of the average interfacial resistance of the electrolyte 100 include an initial resistance of between about 10 ohms (Ω) and about 500Ω, between about 50Ω and about 400Ω, between about 100Ω and about 300Ω, between about 100Ω and 200Ω, between about 170Ω and about 200Ω, and between about 180Ω and about 190Ω.

Referring now to FIG. 2, a Nyquist plot of the resistance of a solid multilayer electrolyte with a FeOCl—LiCl layer and a LLZO layer is shown. It should be understood that a Nyquist plot includes an imaginary number “R′” represented on the y-axis and the interfacial resistance of the electrolyte “R” represented on the x-axis, where R is measured in in ohms ((2). The Nyquist plot shown in FIG. 2 was developed by subjecting the electrolyte to a time-dependent electrochemical impedance spectroscopy (EIS) experiment which subjects the electrolyte to alternating current (AC) signals and measuring the resistance and interfacial resistance of the electrolyte in response to the AC signals over a period of 12 hours (h). The interfacial resistance of the electrolyte was measured at an initial time (0 h), at 4 h, at 8 h, and at 12 h.

As shown in FIG. 2, during the EIS experiment at 0 h, the interfacial resistance ranged from 0 2 to about 20,000Ω. At 4 h, the interfacial resistance ranged from 0Ω to about 30,000Ω. At 8 h, the interfacial resistance ranged from 0Ω to about 40,000Ω. At 12 h, the interfacial resistance ranged from 0Ω to about 50,000Ω. Accordingly, the interfacial resistance of the electrolyte increased steadily over the 12 h experimental time period, which shows that the FeOCl—LiCl and LLZO layers are incompatible with one another (i.e., chemical reactions that retard charge transfer and reduce conductivity occur at the interface between the FeOCl—LiCl and LLZO layers). The area represented by the half-circle shown beneath the plotted points represents the total resistance of the electrolyte at the measured times. The total resistance versus time will now be discussed in relation to FIG. 3.

Referring now to FIG. 3, a plot of the total resistance of the solid multilayer electrolyte of FIG. 2 versus time is shown. As shown in FIG. 3, initially, the total resistance of the electrolyte is at about 25,000Ω, at 4 h the total resistance is about 30,000Ω, at 8 h, the total resistance is about 38,000Ω, and at 12 h, the total resistance is about 50,000Ω. Accordingly, the total resistance of the electrolyte of FIG. 2 increased over the 12 h time period of the EIS experiment, which indicates an incompatibility between the FeOCl—LiCl and LLZO layers.

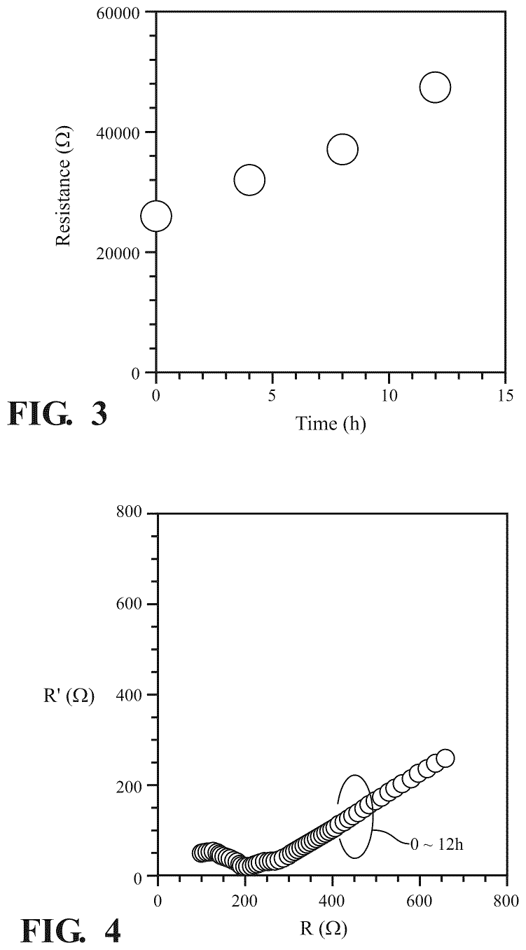

Referring now to FIG. 4, a Nyquist plot of the resistance of a solid multilayer electrolyte with a FeOCl—LiCl layer, a LLZO layer, and an intermediate layer according to the teachings of the present disclosure disposed between the FeOCl—LiCl layer and the LLZO is shown. In one or more variations, the solid multilayer electrolyte is the solid multilayer electrolyte discussed in relation to FIG. 1, where the intermediate layer includes Li, O, C, and P. In particular, the intermediate layer is a material with a composition that is based on Li₃PO₄ and contains at least C and OH. The Nyquist plot shown in FIG. 4 was developed by subjecting the electrolyte to a time-dependent EIS experiment which subjects the electrolyte to AC signals and measuring the resistance and interfacial resistance of the electrolyte in response to the AC signals over a period of 12 hours (h). The interfacial resistance of the electrolyte was measured at an initial time (0 h), at 4 h, at 8 h, and at 12 h.

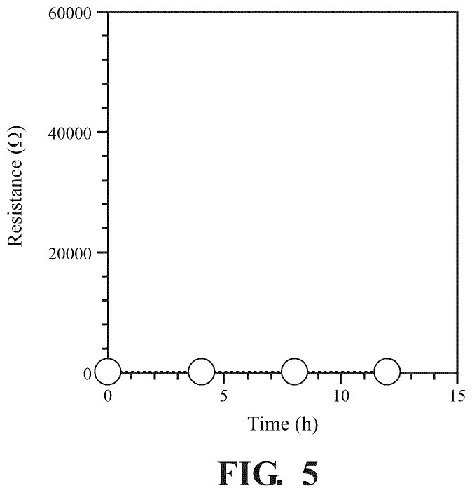

As shown in FIG. 4, during the EIS experiment at 0 h, 4 h, 8 h, and 12 h, the interfacial resistance ranged from 0Ω to about 700Ω. Accordingly, the interfacial resistance of the electrolyte did not increase or substantially change over the 12 h experimental time period, and thereby illustrates the intermediate layer increased the compatibility between the FeOCl—LiCl and LLZO layers in comparison to the electrolyte discussed in relation to FIGS. 2-3 which did not include an intermediate layer. Not being bound by theory, the intermediate layer suppresses chemical reactions at the interface between the FeOCl—LiCl and LLZO layers such that charge transfer and conductivity are enhanced therebetween. The area represented by the half-circle shown beneath the plotted points represents the total resistance of the electrolyte at the measured times. The total resistance versus time will now be discussed in relation to FIG. 5.

Referring now to FIG. 5, a plot of the total resistance of the solid multilayer electrolyte of FIG. 4 versus time is shown. As shown in FIG. 5, the total resistance of the electrolyte over an EIS testing period of 12 hours is about 285Ω. In comparison to the electrolyte discussed in FIGS. 2-3, the total resistance of the electrolyte discussed in relation to FIGS. 4-5 is significantly lower. For example, at 12 h, the total resistance of the electrolyte discussed in relation to FIGS. 2-3 is about 50,000Ω whereas the total resistance of the electrolyte discussed in relation to FIGS. 4-5 is about 285Ω. Accordingly, incorporating an intermediate layer that includes Li, O, C, and P between a FeOCl—LiCl layer and LLZO layer improves the functionality and quality of a solid-state electrolyte including a FeOCl—LiCl layer and LLZO layer.

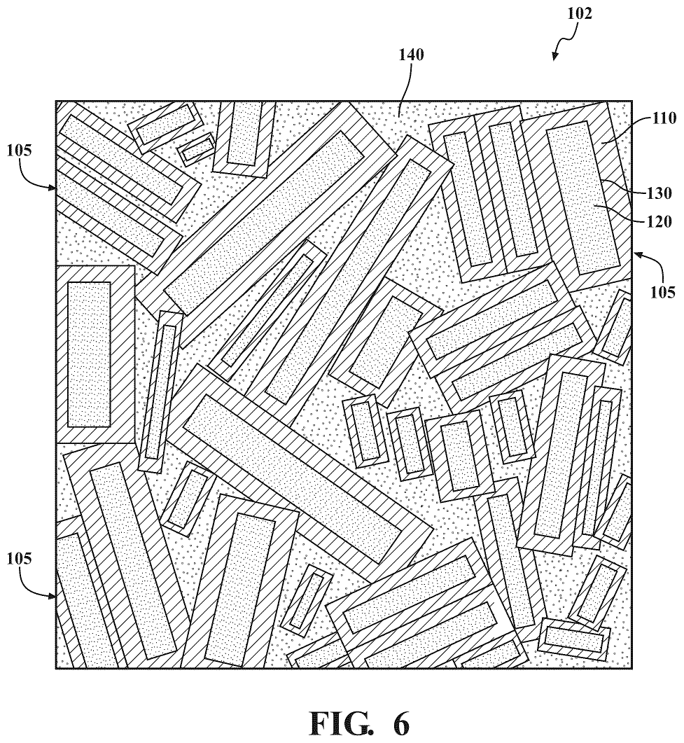

While FIGS. 1 and 4 illustrate the electrolyte 100 with single layers of the FeOCl—LiCl layer 110, the LLZO layer 120, and the intermediate layer 130 (collectively referred to herein as “layers 110-130”), it should be understood that the electrolytes according to the teachings of the present disclosure can include a plurality of repeating layers 110-130. For example, and with reference to FIG. 6, a microstructure of an electrolyte 102 according to the teachings of the present disclosure is shown. The electrolyte 102 includes a Li salt 140 and plurality of particles 105 formed from the FeOCl—LiCl layer 110, the LLZO layer 120, and the intermediate layer 130 embedded within and/or mixed with the Li salt 140. That is, the particles 105 include a core formed from the LLZO layer 120, an outer coating or outer layer formed from the FeOCl—LiCl layer 110, and the intermediate layer 130 disposed between the FeOCl—LiCl layer 110, the LLZO layer 120. In some variations, the Li salt 140 is a Li binary salt, e.g., LiCl. That is, as used herein the phrase “Li binary salt” refers to a Li salt with a composition of LiX1 where X1 is a halide.

The preceding description is merely illustrative in nature and is in no way intended to limit the disclosure, its application, or uses. Work of the presently named inventors, to the extent it may be described in the background section, as well as forms and/or variations of the description that may not otherwise qualify as prior art at the time of filing, are neither expressly nor impliedly admitted as prior art against the present technology.

As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure, and are not intended to limit the disclosure of the technology or any form or variation thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one form or variation, or various forms or variations means that a particular feature, structure, or characteristic described in connection with the form or variation or particular system is included in at least one form or variation of the present disclosure. The appearances of the phrase “in one form” or “in one variation” (or variations thereof) are not necessarily referring to the same form or variation. It should be also understood that the various method steps discussed herein do not have to be carried out in the same order as depicted, and not each method step is required in each form or variation.

The foregoing description of the forms and variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

What is claimed is:

1. A solid electrolyte, comprising:
a lithium lanthanum zirconium oxide (LLZO) solid electrolyte layer;
a FeOCl—LiCl solid electrolyte layer; and
an intermediate layer disposed between the LLZO layer and the FeOCl—LiCl layer, the intermediate layer comprising lithium (Li), oxygen (O), and at least one of phosphorous (P) and carbon (C).

2. The solid electrolyte of claim 1, wherein the intermediate layer further comprises boron (B).

3. The solid electrolyte of claim 1, wherein the intermediate layer is coated directly on the LLZO layer.

4. The solid electrolyte of claim 1, wherein the intermediate layer is coated directly on the FeOCl—LiCl layer.

5. The solid electrolyte of claim 1, wherein the intermediate layer is sandwiched between the LLZO layer and the FeOCl—LiCl layer.

6. The solid electrolyte of claim 1, wherein a thickness of the intermediate layer is between about 1 nm and about 1000 nm.

7. The solid electrolyte of claim 1, wherein a thickness of the intermediate layer is between about 2 nm and about 100 nm.

8. The solid electrolyte of claim 1, wherein an initial resistance of the solid electrolyte is between about 10 ohms and about 500 ohms.

9. The solid electrolyte of claim 1, wherein an initial resistance of the solid electrolyte is between about 200 ohms and about 300 ohms.

10. The solid electrolyte of claim 1, wherein an interfacial resistance of the solid electrolyte is between about 10 ohms and about 500 ohms.

11. The solid electrolyte of claim 1, wherein an interfacial resistance of the solid electrolyte is between about 100 ohms and about 200 ohms.

12. The solid electrolyte of claim 1, wherein the intermediate layer comprises Li, O, and C.

13. The solid electrolyte of claim 1, wherein the intermediate layer comprises Li, O, and P.

14. A solid electrolyte, comprising:
a lithium lanthanum zirconium oxide (LLZO) solid electrolyte layer;
a FeOCl—LiCl solid electrolyte layer; and
an intermediate layer coated on the LLZO layer and sandwiched between the LLZO layer and the FeOCl—LiCl layer, and the intermediate layer comprising lithium (Li), oxygen (O), and at least one of phosphorous (P) and carbon (C).

15. The solid electrolyte of claim 14, wherein the intermediate layer further comprises boron (B).

16. The solid electrolyte of claim 14, wherein a thickness of the intermediate layer is between about 1 nm and about 1000 nm.

17. The solid electrolyte of claim 14, wherein a thickness of the intermediate layer is between about 2 nm and about 100 nm.

18. The solid electrolyte of claim 14, wherein an initial resistance of the solid electrolyte is between about 10 ohms and about 500 ohms.

19. The solid electrolyte of claim 14, wherein an interfacial resistance of the solid electrolyte is between about 10 ohms and about 500 ohms.

20. A solid electrolyte, comprising:
a lithium lanthanum zirconium oxide (LLZO) solid electrolyte layer;
a FeOCl—LiCl solid electrolyte layer; and
an intermediate layer disposed between the LLZO layer and the FeOCl—LiCl layer, the intermediate layer comprising lithium (Li), oxygen (O), and at least one of phosphorous (P) and carbon (C), a thickness of the intermediate layer being between about 1 nm and about 1000 nm, an initial resistance of the solid electrolyte being between about 200 ohms and 300 ohms, and an interfacial resistance of the solid electrolyte being between about 100 ohms and about 200 ohms.
